(19) United States
(12) Patent Application Publication
(10) Pub. No.: US 2014/0083257 A1
(43) Pub. Date: Mar. 27, 2014

(54) POWER DRIVEN RATCHET WRENCH HAVING AN ECCENTRIC YOKE

(71) Applicant: Basso Industry Corp., Taichung (TW)

(72) Inventor: San-Yih Su, Taichung (TW)

(73) Assignee: Basso Industry Corp., Taichung (TW)

(21) Appl. No.: 14/029,253

(22) Filed: Sep. 17, 2013

(30) Foreign Application Priority Data
Sep. 21, 2012 (TW) 101134717

(51) Int. Cl. B25B 21/00

(52) U.S. Cl. CPC B25B 21/004
USPC 81/57.39

(57) ABSTRACT

A power driven ratchet wrench includes a wrench body, an output unit including a driving head rotatable about a Z-axis and adapted for outputting a power, a driving unit including a rotor rotatable about an X-axis perpendicular to the Z-axis, and a transmission unit. The transmission unit includes an eccentric projection connected eccentrically to the rotor and rotatable about the X-axis, two racks connected to the output unit, and an eccentric yoke disposed pivotally in the wrench body. A yoke body of the yoke has a slot permitting the eccentric projection to move therein, and a connecting portion connected to the racks at positions misaligned from the X-axis. The X-axis extends through the slot. The connecting portion drives the racks and the driving head to rotate.

### CROSS-REFERENCE TO RELATED APPLICATION

This application claims priority of Taiwanese Application No. 101134717, filed on Sep. 21, 2012.

### BACKGROUND OF THE INVENTION

1. Field of the Invention

This invention relates to a ratchet wrench, and more particularly to a power driven ratchet wrench having an eccentric yoke.

2. Description of the Related Art

Referring to FIG. 1, a conventional power driven ratchet wrench 1 includes a wrench body 11, a driving head 12 extending rotatably from the wrench body 11 along a Z-axis, a yoke 13, a pawl unit 14, and an air motor 16. The wrench body 11 has an intake passage 111 for fluid communication with a compressed air source (not shown). The yoke 13 extends along a X-axis, and has a sleeve portion 131 geared to the driving head 12, and a slot 132. The pawl unit 14 includes a pawl 141 disposed between the sleeve portion 131 and the driving head 12 and rotatable between two positions for controlling the rotational direction of the driving head 12, and a direction switching button 142 operable for controlling rotation of the pawl 141 between the two positions. The air motor 16 includes an air cylinder 161 in fluid communication with the intake passage 111, a rotor 162 disposed within the air cylinder 161 and driven pneumatically to rotate about the X-axis, a rotating shaft 163 connected coaxially to the rotor 162, and an eccentric projection 164 disposed eccentrically on the rotating shaft 163 and extending into the slot 132 in the yoke 13.

When the rotor 162 drives rotation of the rotating shaft 163, the eccentric projection 164 rotates about the X-axis to swing the yoke 13 so as to allow the sleeve portion 131 drives the driving head 12 to rotate, such that the driving head 12 is limited by the pawl unit 14 to rotate in a single direction.

However, since the air motor 16 and the yoke 13 extend along the X-axis, to satisfy the need of miniaturization, arrangement of other components is limited so that a change in the width of the ratchet wrench is comparatively large, thereby resulting in difficulties in designing the shape of the ratchet wrench.

### SUMMARY OF THE INVENTION

The object of this invention is to provide a power driven ratchet wrench whose shape is convenient to design.

According to this invention, there is provided a power driven ratchet wrench comprising:

a wrench body;

an output unit mounted to the wrench body and including a driving head rotatable about a Z-axis and adapted for outputting a power;

a driving unit mounted to the wrench body and including a rotor rotatable about an X-axis perpendicular to the Z-axis; and

a transmission unit mounted to the wrench body and including an eccentric projection connected eccentrically to the rotor and rotatable about the X-axis, two racks connected to the output unit, and an eccentric yoke disposed pivotally in the wrench body and including a yoke body that has a slot formed at one end thereof and permitting the eccentric projection to move therein when the rotor is rotated, and a connecting portion disposed at the other end thereof and connected to the racks at positions misaligned from the X-axis, the X-axis extending through the slot, the connecting portion driving the racks and the driving head to rotate.

Since connections between the connecting portion and the racks are misaligned from the X-axis, it is not necessary to arrange many components of the ratchet wrench along an axis, thereby allowing for more change in designing the shape of the ratchet wrench.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a sectional view of a conventional power driven ratchet wrench;

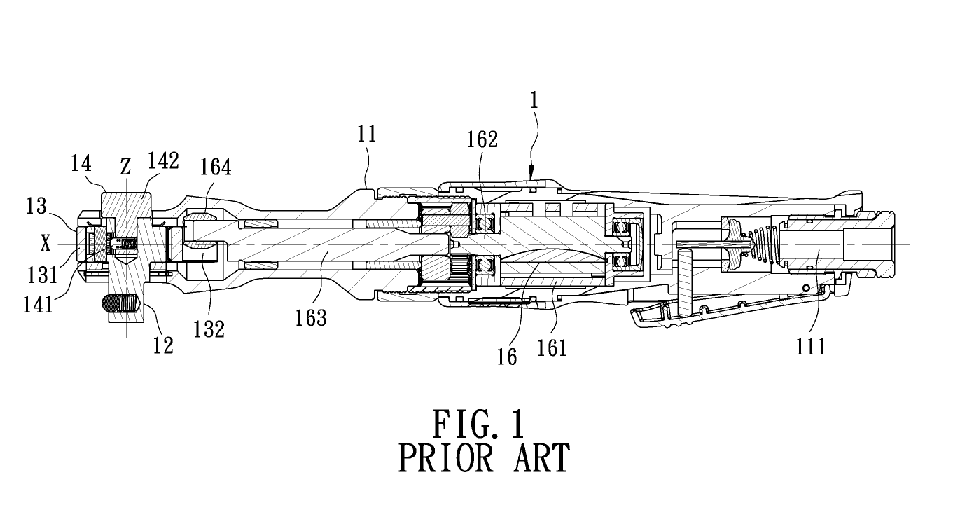

FIG. 2 is a sectional view of the preferred embodiment of a power driven ratchet wrench according to this invention;

FIG. 3 is an exploded perspective view of an eccentric yoke of the preferred embodiment; and

FIG. 4 is another sectional view of the preferred embodiment.

### DETAILED DESCRIPTION OF THE PREFERRED EMBODIMENT

Before the present invention is described in greater detail in connection with the preferred embodiments, it should be noted that similar elements and structures are designated by like reference numerals throughout the entire disclosure.

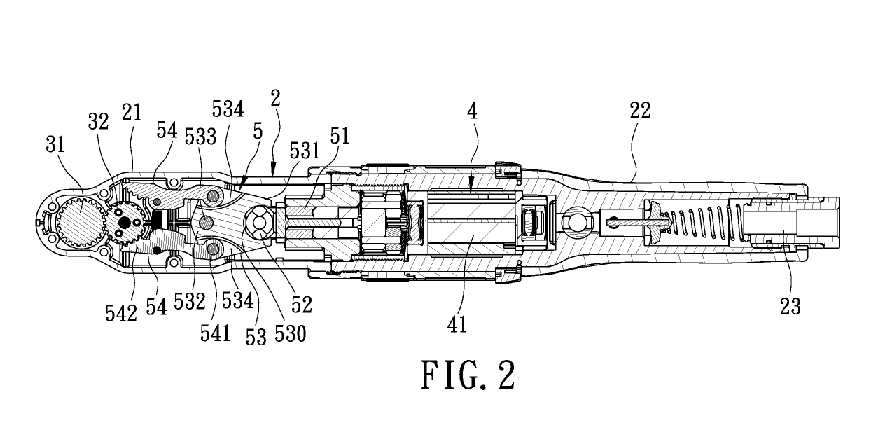

Referring to FIGS. 2, 3, and 4, the preferred embodiment of a power driven ratchet wrench according to this invention includes a wrench body 2, an output unit 3, a driving unit 4, and a transmission unit 5.

The wrench body 2 has a front end section 21 extending along an X-axis, a rear end section 22 opposite to the front end section 21 and permitting a hand of a user to grip, and an intake passage 23 formed in the rear end section 22 and permitting compressed air to be fed into the ratchet wrench therethrough.

The output unit 3 is mounted to the front end section 21 of the wrench body 2, and includes a driving head 31 rotatable about a Z-axis perpendicular to the X-axis for outputting a power, and a ratchet wheel 32 geared to the driving head 31.

The driving unit 4 includes an air cylinder 41 in fluid communication with the intake passage 23 and permitting the compressed air to flow therethrough, and a rotor 42 disposed rotatably within the air cylinder 41 and rotatable about the X-axis in response to flow of the compressed air through the air cylinder 41.

The transmission unit 5 is mounted to the wrench body 2, and includes a rotating shaft 51, an eccentric projection 52, an eccentric yoke 53, and two racks 54. The rotating shaft 51 is connected coaxially to the rotor 42 along the X-axis at one end thereof. The eccentric projection 52 is connected integrally and eccentrically to the other end of the rotating shaft 51, such that the rotating shaft 51 cooperates with the eccentric projection 52 to serve as a crankshaft unit. The eccentric yoke 53 includes a yoke body 53′ and a pivot pin 533. The yoke body 53′ has a curved wall 531 defining a slot 530 formed at one end of the yoke body 53′, and a connecting portion 532 disposed at the other end of the yoke body 53′. The slot 530 extends along a direction parallel to the Z-axis, and has a middle portion that permits the X-axis to pass therethrough, as shown in

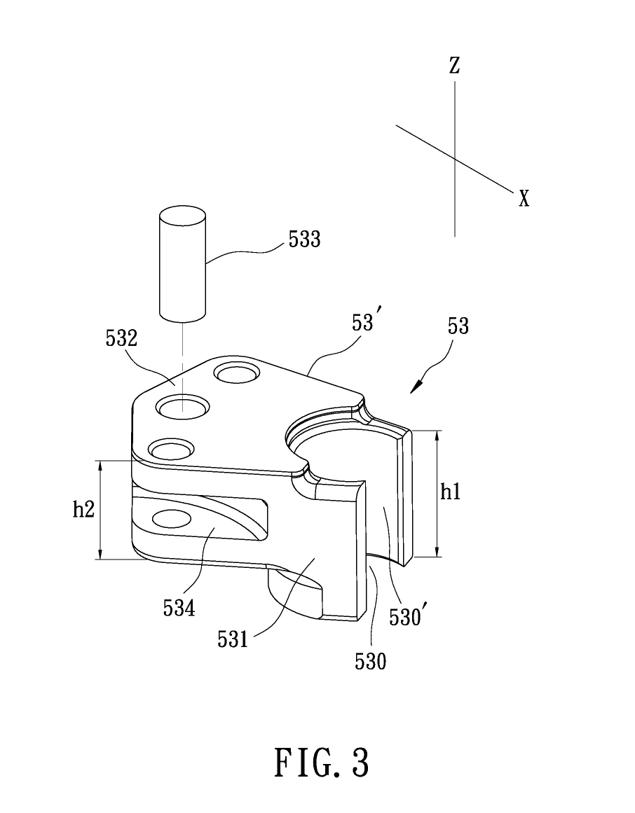

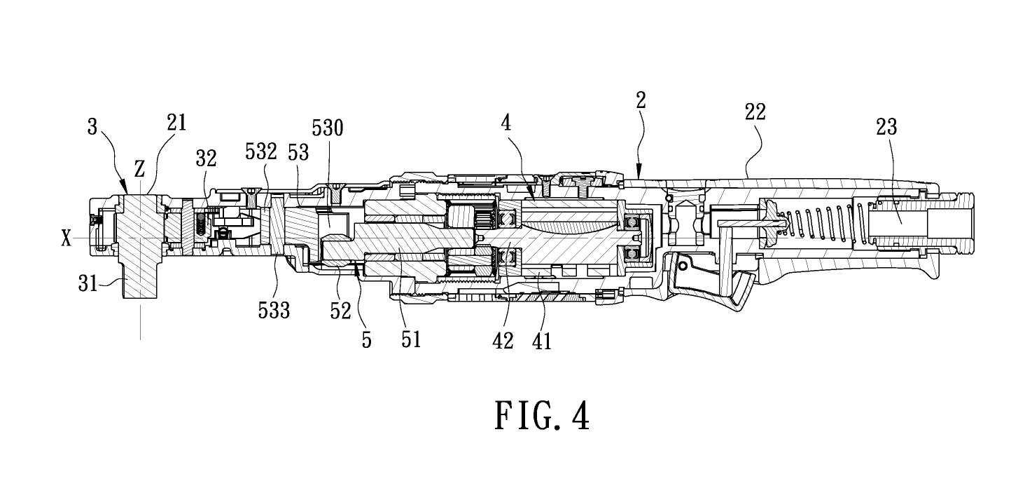

FIG. 4. The curved wall 531 has a C-shaped cross-sectioned inner wall surface 530′ for defining the slot 530. The pivot pin 533 extends through the connecting portion 532 and a wall of the front end section 21 of the wrench body 2 in a direction parallel to the Z-axis for connecting the yoke body 53′ pivotally to the wrench body 2. The yoke body 53′ further has two recesses 534 formed in the connecting portion 532 and disposed respectively at two sides of the pivot pin 533. When the rotor 42 rotates, the eccentric projection 52 moves in the slot 530. The height (h1) of the curved wall 531 in a direction parallel to the Z-axis is greater than the height (h2) of the connecting portion 532. The racks 54 are disposed respectively at two sides of the ratchet wheel 32. Each of the racks 54 has an end 541 extending into and disposed pivotally in the corresponding recess 534 in the yoke body 53′, and an toothed section 542 capable of meshing with the ratchet wheel 32. With particular reference to FIG. 3, the recesses 534 are formed in a middle portion of the connecting portion 532. With particular reference to FIG. 4, the middle portion of the connecting portion 532 is connected pivotally to the racks 54 at two positions misaligned from the X-axis.

It should be noted that, the racks 54 are controlled by a direction switching device (not shown) in a known manner, such that one of the racks 54 can mesh with the ratchet wheel 32 at a time.

When the rotating shaft 51 is driven by the rotor 42 to rotate about the X-axis, the eccentric projection 52 moves in the slot 530 in the yoke body 53′ to swing the eccentric yoke 43. Hence, the racks 54 move in opposite directions to engage the ratchet wheel 32 with one of the racks 54 to thereby rotate the driving head 31 in a single direction.

Since connections between the connecting portion 532 of the eccentric yoke 53 and the racks 54 are misaligned from the X-axis, there is no need to arrange the driving head 32, the ratchet wheel 32, the racks 54, and the rotor 42 along an axis. That is, many components can be disposed at aside of the X-axis, as show in FIG. 4, so as to minimize a change in the width of the ratchet wrench, while still satisfying the need of miniaturization. In this manner, the shape of the ratchet wheel is convenient to design.

With this invention thus explained, it is apparent that numerous modifications and variations can be made without departing from the scope and spirit of this invention. It is therefore intended that this invention be limited only as indicated by the appended claims.

I claim:

1. A power driven ratchet wrench comprising:
a wrench body;
an output unit mounted to said wrench body and including a driving head rotatable about a Z-axis and adapted for outputting a power;
a driving unit mounted to said wrench body and including a rotor rotatable about an X-axis perpendicular to the Z-axis; and
a transmission unit mounted to said wrench body and including an eccentric projection connected eccentrically to said rotor and rotatable about the X-axis, two racks connected to said output unit, and an eccentric yoke disposed pivotally in said wrench body and including a yoke body that has a slot formed at one end thereof and permitting said eccentric projection to move therein when said rotor is rotated, and a connecting portion disposed at the other end thereof and connected pivotally to said racks at two positions misaligned from the X-axis, the X-axis passing through said slot, said connecting portion driving said racks and said driving head to rotate.

2. The power driven ratchet wrench as claimed in claim 1, wherein said output unit further includes a ratchet wheel geared to said driving head, and said racks are disposed respectively at two sides of said ratchet wheel, and are moved in opposite directions such that one of said racks can mesh with said ratchet wheel at a time.

3. The power driven ratchet wrench as claimed in claim 1, wherein said eccentric yoke further includes a pivot pin extending through said connecting portion for connecting said yoke body pivotally to said wrench body, and said yoke body further has two recesses formed in said connecting portion and each permitting an end of a respective one of said racks to extend thereinto.

4. The power driven ratchet wrench as claimed in claim 3, wherein said recesses in said connecting portion of said eccentric yoke are disposed respectively at two sides of said pivot pin.

5. The power driven ratchet wrench as claimed in claim 1, wherein said yoke body further has a curved wall, said curved wall having a C-shaped cross-sectioned inner wall surface for defining said slot, the height of said curved wall in a direction parallel to the Z-axis being greater than that of said connecting portion.

6. The power driven ratchet wrench as claimed in claim 1, wherein said driving unit further includes an air cylinder, said rotor being disposed rotatably within said air cylinder and being rotatable within said air cylinder in response to flow of compressed air through said air cylinder.

7. The power driven ratchet wrench as claimed in claim 1, wherein said transmission unit further includes a rotating shaft connected coaxially to said rotor at one end thereof, said eccentric projection being connected integrally and eccentrically to the other end of said rotating shaft such that said rotating shaft cooperates with said eccentric projection to serve as a crankshaft unit.
